(19) United States
(12) Patent Application Publication
(10) Pub. No.: US 2017/0230457 A1
(43) Pub. Date: Aug. 10, 2017

(54) Idempotent Server Cluster

(71) Applicant: Microsoft Technology Licensing, LLC, Redmond, WA (US)

(72) Inventors: Namendra Kumar, Redmond, WA (US); Abhilash C. Nair, Bellevue, WA (US); Uladzimir A. Skuratovich, Redmond, WA (US); Adit Dalvi, Redmond, WA (US)

(21) Appl. No.: 15/016,668

(22) Filed: Feb. 5, 2016

(51) Int. Cl. H04L 29/08; G06F 17/30

(52) U.S. Cl. CPC H04L 67/1097; H04L 67/1004; G06F 17/30952

(57) ABSTRACT

In a cluster of servers, each server is configured as follows. A request is received at the server from a requesting entity. The request includes an identifier of the request. The server determines whether the request identifier is already associated with any of the servers in a cluster database. If the request identifier is already associated with a different one of the servers in the cluster database, it is forwarded to the different server. If the request identifier is not already associated with any of the servers, it is associated with the server. The server generates a response to the request, and, stores in local storage accessible to the server and transmits a copy of it to a requesting entity. If the request is already associated with the server in the cluster database, the server locates any response to the request that is already stored in the local storage.

### BACKGROUND

A communication event may be established between an initiating device (that is, a calling device) and at least one responding device (that is a callee device). The communication event may for example be a call (audio or video call), a screen or whiteboard sharing session, other real-time communication event etc. The communication event may be between the initiating device and multiple responding devices, for example it may be a group call. The communication event may be established by performing an initial signalling process, in which messages are exchanged via a network, so as to provide a means by which media data (audio and/or video data) can be exchanged between the devices in the established communication event. The signalling phase may be performed according to various protocols, such as SIP (Session Initiating Protocol) or bespoke signalling protocols. The media data exchange rendered possible by the signalling phase can be implemented using any suitable technology, for example using Voice or Video over IP (VoIP), and may or may not be via the same network as the signalling.

The communication event may be established under the control of a communications controller, such as a call controller. That is, the communications controller may control at least the signalling process. For example, all messages of the signalling process sent to the caller and callee devices may be sent from the communication controller, and between the devices themselves. For example, the calling device may initiate the signalling process by sending an initial request to the communications controller, but the communications controller may have the freedom to accept or reject the initial request. If the initial request is accepted, the communications controller itself may send out call invite(s) to the call device(s), and the responding device(s) in turn may respond to the communications controller (not the initiating device directly).

The communication controller may be implemented by a server cluster, comprising multiple, cooperating servers. For example, multiple servers located behind a common load balancer. Other types of service may be provided by server clusters also. For example, the cluster may be implemented in a cloud computing context, wherein the multiple servers in the cluster provide robustness and failure tolerance.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various aspects of the present subject matter are directed to the processing duplicate requests within a server cluster comprising a plurality of servers. The servers have access to a cluster database for associating individual servers of the cluster with request identifiers. Each of the server is configured to implement the following steps. A request is received at the server from a requesting entity (e.g. a client external to the cluster, or another of the servers). The request includes an identifier of the request. The received request is processed by the server, by applying the following operations. The server determines whether the request identifier is already associated with any of the servers in the cluster database, and proceeds as follows depending on the determination:
If the request identifier is already associated with a different one of the servers in the cluster database, it is forwarded to the different server for processing thereat.
If the request identifier is not already associated with any of the servers in the cluster database, it is associated with the server therein. The server generates a response to the request, and, once generated, stores the response in association with the request identifier in local storage accessible to the server and transmits a copy of it to a requesting entity.
If the request is already associated with the server in the cluster database, the request identifier is used to locate any response to the request that is already stored in the local storage accessible to the server, and if located a copy of it is transmitted to the requesting entity.

### BRIEF DESCRIPTION OF FIGURES

For a better understanding of the present subject matter, and to show how embodiments of the same may be carried into effect, reference is made by way of example to the following figures, in which:

FIG. 1 shows a schematic block diagram of a communication system, which includes a server cluster;

FIG. 2 shows a schematic block diagram of physical server configured to implement a plurality of virtual servers;

FIG. 3 shows a schematic representation of a request generated by a client;

FIG. 4 schematically illustrates a layered architecture of a server;

FIG. 5 shows a flow chart for an idempotent request handling method implemented within a server cluster;

FIG. 6A shows a signaling diagram for the handling of a retry when a response from a server to a client is lost;

FIG. 6B shows a signaling diagram for the handling of retry when a response from a server is delayed;

FIG. 6C is a signalling diagram for idempotent request proxying within a server cluster;

FIG. 7 is a signalling diagram for an idempotent communication event establishment procedure.

### DETAILED DESCRIPTION OF EMBODIMENTS

The aspects set out in the previous section allow the server cluster as a whole to exhibit “idempotent” behavior. The concept of idempotency is well known in the art, and refers to a paradigm by which duplicate requests, such as retries, do not result in unintended duplication of results. That is, such that the effect of multiple, duplicate requests received at a server (or in this case a server cluster) is the same as a single request.

As is known in the art, the servers within a sever cluster are coupled in a manner such that, to at least some extent, they operate as a single system when viewed externally. The tightness of the coupling can vary depending on the context. For example, in the context of cloud computing, a cluster of virtual servers (“server instances”) may run the same code as one another, and operate in a largely stateless manner i.e. such that any one of the servers is equally well equipped to handle any incoming request. Whist in some respects this is desirable, rigidly enforcing stateless behavior within the cluster can be inefficient, e.g. requiring frequent serialization and centralized storage of server state (so that, in effect, any server can pick up from where another server left off).

In particular, rigidly enforcing stateless behavior to the extent that any server in the cluster is equipped to handle a duplicate request in an idempotent manner, irrespective of whether or not it received the original request, may be impracticable.

As such, to provide an idempotency server cluster without requiring such rigidly stateless behavior, the aspects of the present subject matter set out in the Summary section provide a mechanism which ensures that any duplicate request received at the server cluster is forwarded to whichever server received the original for processing thereat, which can based on data held in its local storage (e.g. local memory) that may not be directly accessible to other servers in the cluster.

Typically, a server cluster will have at least one network address that is externally visible, for example provided by a load balancer, behind which the servers are located. Messages received at the load balancer are then forwarded to an available one of the servers in the cluster, according to a suitable load balancing algorithm e.g. in a round-robin fashion, based on server load etc.

One alternative to the present subject matter would be for the load balancer itself to attempt to distinguish original requests from duplicate requests, based on request IDs contained therein. However, there are several issues with this approach.

Firstly, this alternative can lead to security issues: in this scenario, the load balancer would need to read the request ID in each incoming request to determine which server to send it to, meaning that, if messages IDs are encrypted, they would need to be decrypted by the load balancer itself. For example, it may be desirable for the client to communicate its requests to the server via a secure connection (e.g. TLS/SSL)—but in this scenario, that connection would have to terminate with the load balancer rather than within the cluster itself, which may be detrimental to end-to-end security. Secondly, in practical contexts load balancers tend to be implemented using somewhat specialized, dedicated hardware. Even though, in some cases, their operations are implemented by software executing on this hardware, such hardware is generally designed with the primary aim of allowing the load balancer to forward requests to an available server in the shortest time possible. This means that, in many cases, such hardware is not well suited to extending the functionality of the load balancer in this manner, without significantly increasing the time it takes for the load balancer to perform its primary function.

Accordingly, the present invention uses message forwarding within the cluster itself to provide idempotent request processing by the cluster as a whole. This approach not only overcomes the issues outlined in the preceding paragraph, but does so in a manner that is sufficiently flexible to permit stateful behavior of the servers within the cluster to any desired extent. With regards to the latter, this allows in particular the response to the request to be stored in the local storage of the server that generated it (e.g. in local in-memory storage) which need not be directly accessible to the other server(s) in the cluster.

In embodiments, the server cluster of the present disclosure may be configured to operate as a call (or other communication event) controller. In this context, a requesting client transmits one or more requests to the call controller, in a call signaling phase, in order to establish a communication event between the requesting client and a target client under the control of the call controller. The inventors have found, in particular, that attempting to configure the load balancer itself to handle duplicate requests can lead to a significant increase in call setup times, i.e. the time between a user of the requesting client instigating the call (or other communication event) and the time at which media data (audio and/or video data) begins to flow between the clients. By contrast, the approach of the present disclosure can be used to provide an idempotent communications (e.g. call) controller with minimal impact on call set up times.

Duplicate requests can occur for a number of reasons. In a client-server infrastructure, there are often cases where:
Requests (i.e. messages from a client to a server) are lost in a network and never make it to server;
Request processing is delayed on the server, causing the client to be think that request was lost in network when in fact it is still being generated;
Responses from the server to the client are lost or delayed in network.

These issues can occur even if the client relies on a reliable transport protocol like TCP, because of possible interruptions in the transport that may happen anytime (router crash etc.).

Applications typically rely on client side retries to improve resiliency against such network issues, but this creates a challenge when the processing of request causes side effects on server.

For example, in establishing a communications event, such as a call, over a network, a requesting communications client (i.e. caller) may instigate a “Start Call” command so as to transmit a call request to a server, which identifies a target communication client(s) for the communication event (i.e. callee(s)). In response to receiving the request, the server may transmit a response to the caller client and a call invite to the identified callee client. If the original request made it to the server but response did not make it to the client, the caller client may retry the Start Call command, which can result in multiple calls being unintentionally created if not handled properly.

The issue becomes more complex when the client talks to a “server cluster”. A server cluster refers to a plurality of interconnected servers which cooperate to provide a single service. For example, a server cluster may comprise a load balancer and a plurality of interconnected servers that are behind the load balancer.

The added complexity arises because a retry may land on a different server than the original request.

This document solves this by providing mechanisms for the handling of retries received from a client within a server cluster, such that the retries do not result in duplicate (and wrong) processing/side-effect, even when they land on a different server in the cluster on each attempt.

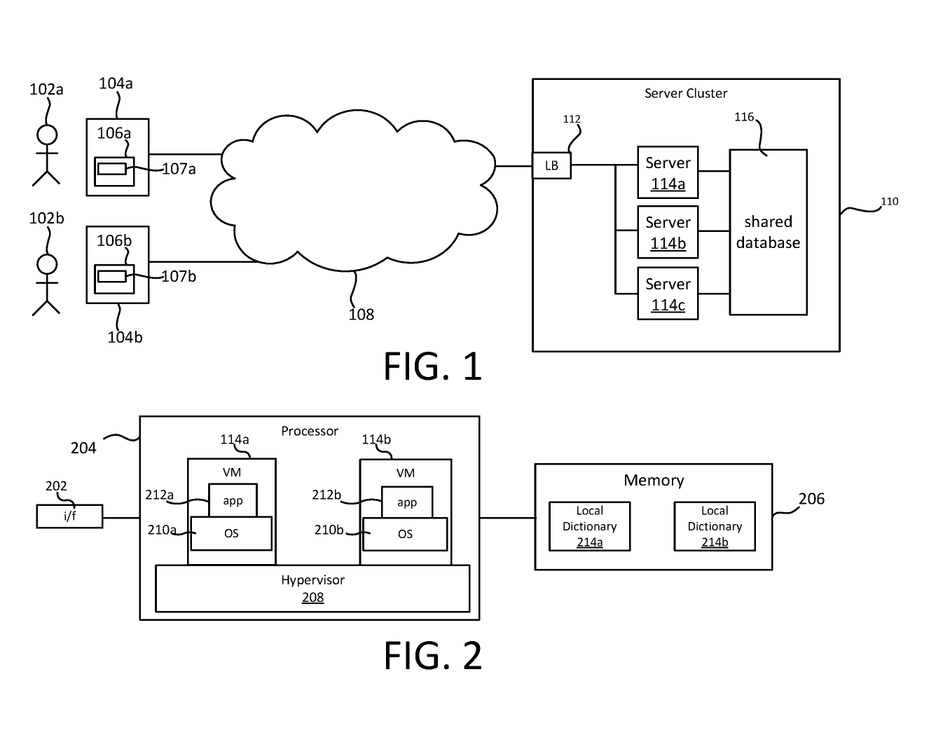

FIG. 1 shows a communication system, which comprises a communications network 108 and, connected to the network 108, a first client device 104a, a second client device 104b, and a server cluster 110. The client devices 104a, 104b are user devices in this example, each operated by a respective user 102a, 102b. For example, the user devices 104a, 104b may be desktop or laptop computer devices, smartphones, tablet devices, smart televisions, wearable computing devices or any other form of user device. Each of the client devices 104a, 104b comprises a respective processor 106a, 106b (e.g. comprising a CPU or multiple interconnected CPUs, such as in a multicore processor) on which a respective client is running 107a, 107b. The clients can be any suitable software for communicating with servers in the server cluster, and may for example be communication clients (e.g. VoIP, that is Voice over IP clients), web browsers, or any other suitable type of application.

The server cluster 110 comprises a plurality of servers (first, second and third servers 114a, 114b, 114c are shown), a load balancer 112 via which each of the servers 114a, 114b, 114c is connected to the network 108, and a cluster database 116. The cluster database 116 is internal to the cluster 110 and is shared in the sense that each of the servers 114a, 114b, 114c in the cluster 110 has access to it, such that a record (i.e. entry) created or modified in the shared database 116 by any one of the servers 114a, 114b, 114b is visible to all of the servers 114a, 114b, 114c in the cluster 110. Each of the servers 114a, 114b, 114c in the cluster 110 has a server identifier (ID) that is unique within the cluster 110. Although three servers are shown, this is exemplary and the cluster 10 may comprise more or fewer servers.

The shared database 116 may for example be implemented in shared storage of the cluster, for example implemented using REDIS, Memcache, Azure Table Store, SQL server etc. Where server virtualization is used (see below), the shared storage may for example be implemented as a separate virtual machine within the cluster, i.e. an additional server instance within the cluster 110.

The database 116 comprises a plurality of entries, each of which comprises a key-value pair. The shared database 116 supports at least create and retrieve (i.e. get) operations for creating and retrieving an entry of the database respectively. The create operation takes a desired key and a desired value, to be included in the new entry, as inputs. The retrieve operation takes a target key as its input, and returns any record with the target key. The create operation supports optimistic concurrency, such that create fails if an entry with the target key already exists.

The network 108 is a packet based network having a layered architecture, such as the Internet. The layered architecture includes a transport layer configured to provide end-to-end connectivity between hosts of the network, such as the client devices 104a, 104b and servers 114a, 114b, 114c, and an application layer above the transport layer which provides process-to-process communication between different processes running on such hosts. One or more lower layers, below the transport layer, may provide for lower layer communications of data, e.g. though a combination of routing and switching. The layered architecture may for example be in accordance with the TCP/IP Protocol Suite.

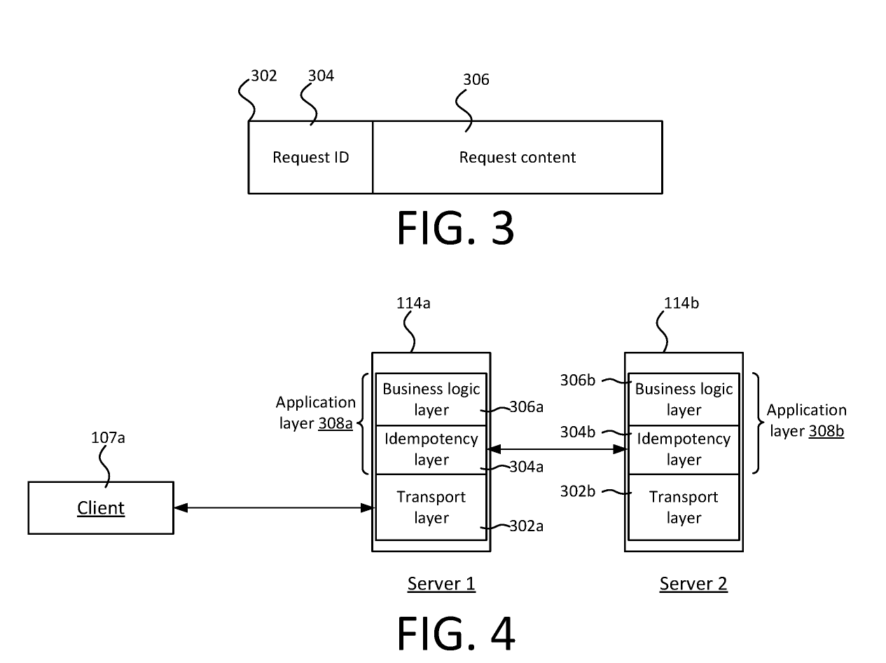

Each of the servers 114a, 114b, 114c is a virtual server in this example, as illustrated in FIG. 2. FIG. 2 shows a physical processor 204 and, connected to the processor 204, a network interface 202 and a local memory 206, which is in the form of in-memory storage. The local memory 206 is directly accessible by the processor 204. The processor 204, network interface 202 and local memory 206 may for example be integrated in a physical server device. A hypervisor 208 is shown running on the processor 204. The hypervisor 204 is a piece of computer software that creates, runs and manages virtual machines, such as the first and second virtual servers 114a, 114b. A respective operating system 210a, 201b (e.g. Windows Server™) runs on each of the virtual servers 114a, 114b. Respective application code 212a, 212b runs on each operating system 210a, 210b. The virtual servers can communicate with external components, such as the load balancer 112, via the network interface 202.

For each of the virtual servers 114a, 114b, a respective local dictionary is shown 214a, 214b implemented in the local memory 206. The dictionaries 214a, 214b are local in the sense that they are only directly accessible to the corresponding server 114a, 114b. Because they are implemented in the memory 206 that is directly accessible to the physical processor 204 on which the virtual servers 114a, 114b are running, the virtual servers 114a, 114b can access them quickly. Each of the dictionaries 214a, 214b also supports at least create and retrieve operations for creating and retrieving an entry in that dictionary respectively. Entries are indexed by a desired value. The create operation fails for a target index if an entry with the target index already exists in that dictionary.

Whilst in this example, the first and second virtual servers 114a, 114b are running on the same physical processor 204, this is purely by way of example, and they may equally be running on different physical processors. In general, the virtual servers of the server cluster 110 may be distributed between one or more physical processors in any suitable manner e.g. within a datacentre. Where they are distributed across physical devices, a direct communications infrastructure may be provided between those devices to enable fast communication between them. Virtual servers are equivalently referred to herein as a server instances.

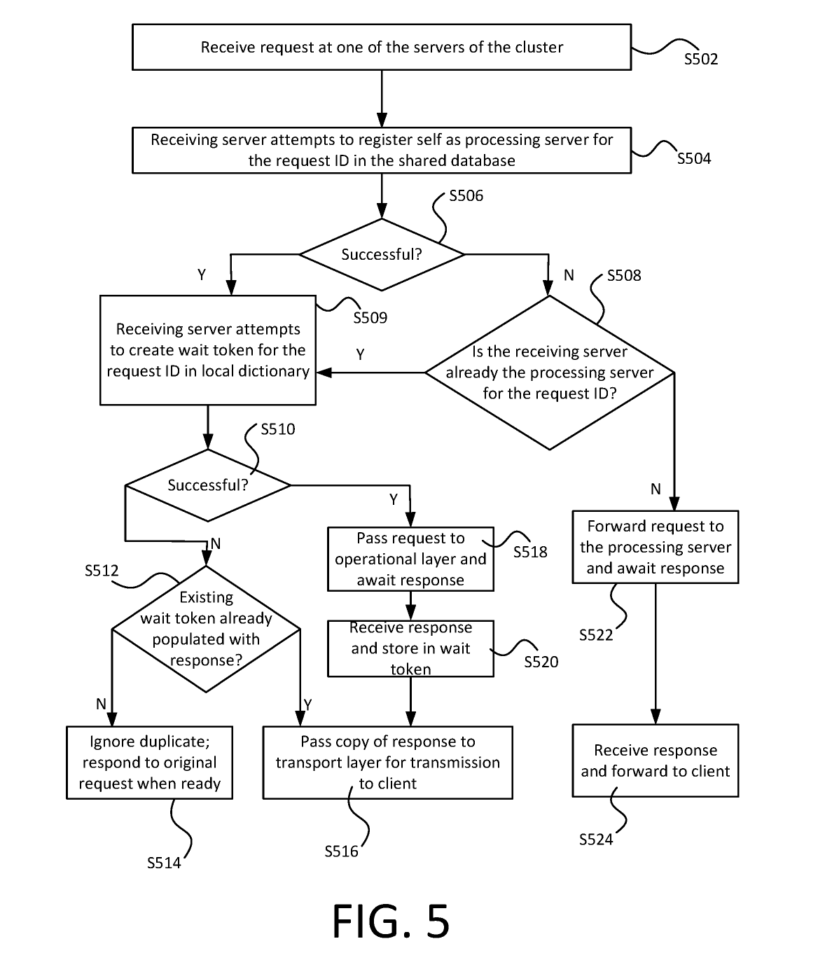

FIG. 3 shows the format of a request message 302 generated by the client 107a. The request 302 has a request ID field 302, containing a unique ID of the request 302, and at least one content field 306. For requests made over HTTP the request ID filed 302 may be the standard HTTP header, and the content field 306 the standard HTTP payload. For other protocols the request ID can be carried in the payload any way application chooses in a manner that is understood by the client and each server. The request 302 identifies the client 107a, for example it may comprise a network address of the client, e.g. a transport address i.e. an IP address of the user device 106a and an associated port associated with that IP address that is available to the client 107a.

The request ID is a globally unique identifier and remains the same across retries. That is, if the client 107a intentionally generates a duplicate of a request it has previously sent, because it has not yet received a response, the duplicate contains the same request ID. That is, a request and any duplicates thereof have matching request IDs.

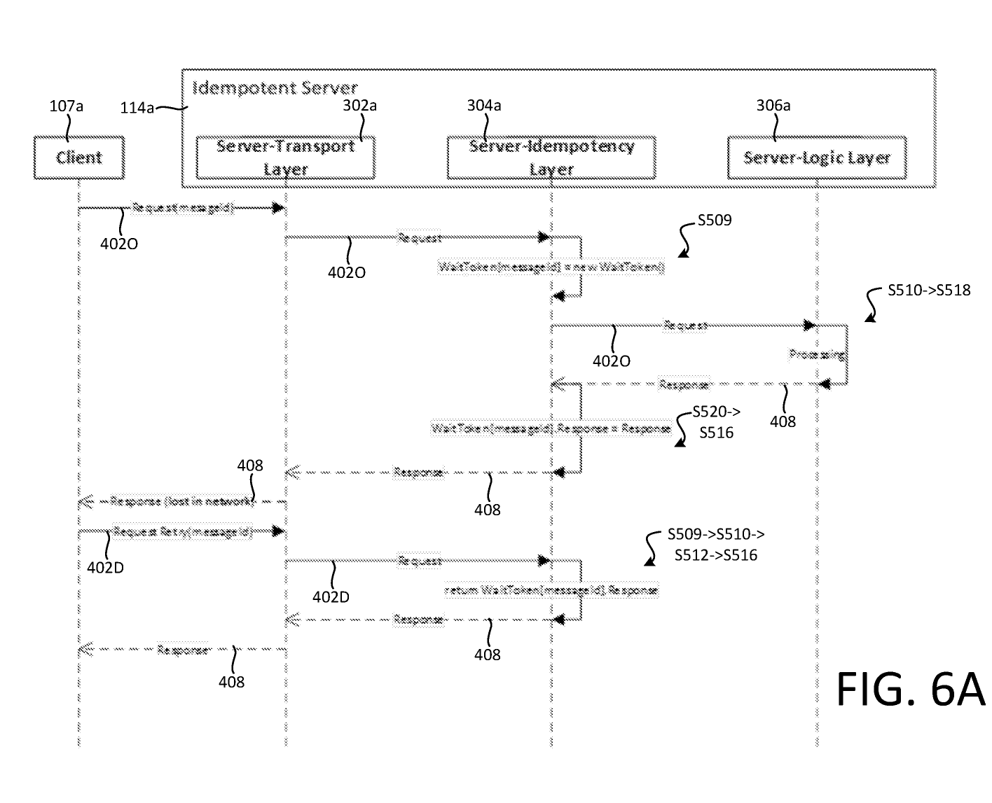

FIG. 4 shows a highly schematic illustration of the architecture of servers within the cluster 110. The first and second servers 114a, 114b are shown by way of example, and each is configured to implement a respective transport layer 302a, 308a and a respective application layer 308b, 308b above the respective transport layer 302a. The application layer comprises a respective idempotency layer 304a, 304b and a respective business logic layer 306a, 306b above the idempotency layer 304a, 304b. The terms operational layer and business logic layer are used interchangeably herein. The servers may implement additional layers, such as lower network and link layers (not shown) in the manner of conventional network architecture.

A request 302 from the client 107a to the first server 114 is received at the transport layer 302a of the first server 114a, and passed up to the idempotency layer 304a for initial processing. As described in detail below, depending on the circumstances, the idempotency layer 304a may pass the request 302 up to the business logic layer 306a, pass it to the idempotency layer of a different server in the cluster 110, such as the second server 114b, or handle the request 302 itself entirely.

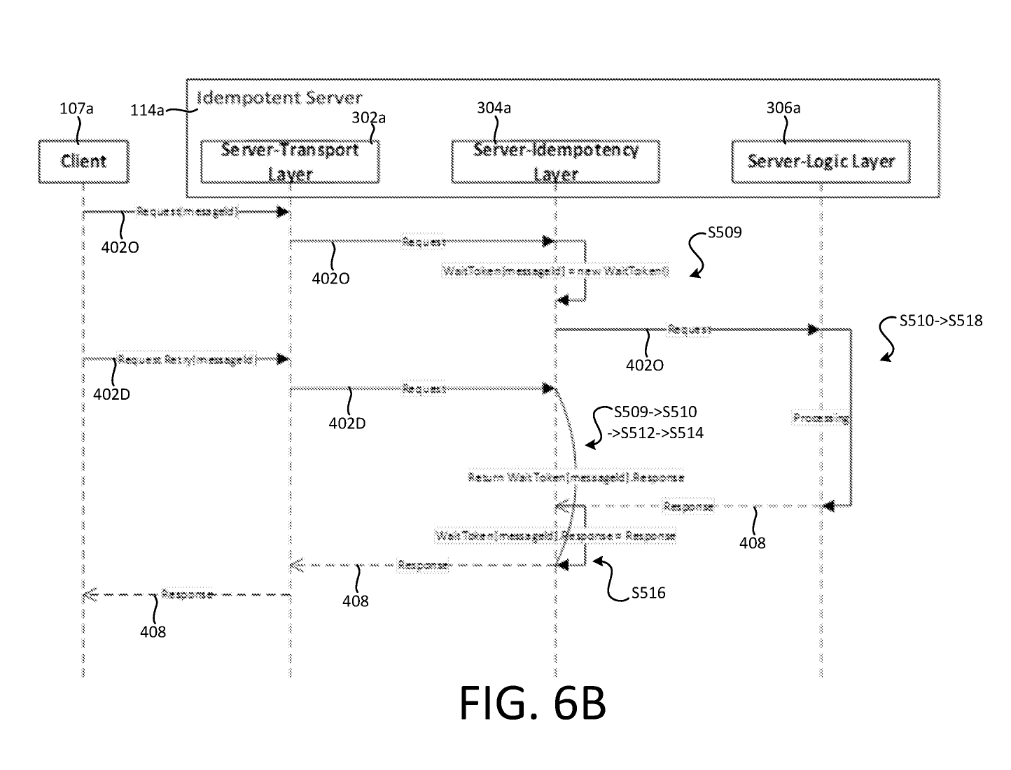

FIG. 5 shows a flowchart for an idempotent request handling method implemented within the server cluster 110. The method is a computer implemented method, which the idempotency layer of each of the servers 114a, 114b, 114c is configured to implement. The steps of the method are implemented separately by each of the servers 114a, 114b, 114c in the cluster 110, for each request that is received at that server. Purely for the purposes of illustration, the follow example considers the implementation by the idempotency layer 504a of the first server 114a, but the description applies equally to the idempotency layers of the other server(s) in the cluster 110.

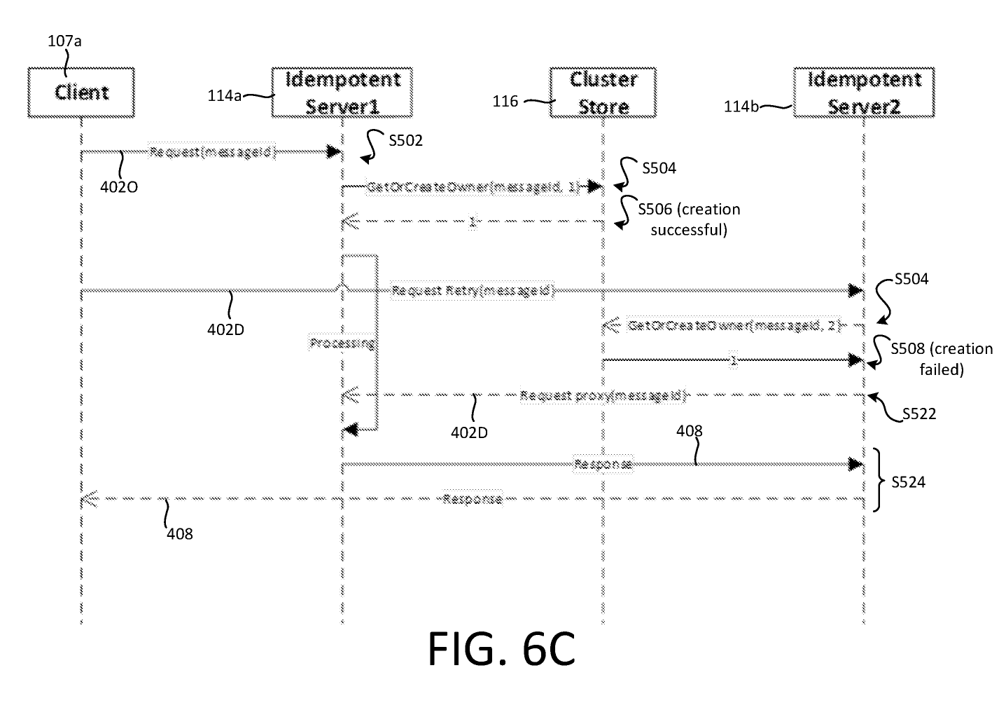

FIGS. 6A, 6B and 6C are signaling diagrams illustrating a selection of examples of how the method can progress in different circumstances, and are described in conjunction with FIG. 5. Like reference numerals are used across these figures to denote correspondences between the method steps of FIG. 5 and the signaling flows of FIGS. 6A-6C. In FIGS. 6A-6C, original requests are denoted 402O, whereas duplicate requests are labelled 402R. When an original request 402O is received from a client 107 at the load balancer 112, it can be forwarded by the load balancer 112 to any one of the servers in the cluster 110, as selected by the load balancer 112 according to whatever load balancing mechanism it is implementing. That server becomes the “owner” of that request, in that it handles the processing of the request and ultimately handles the processing of any duplicates of that request that are received at the cluster 110. It is referred to as the processing server for its request ID, noting that because an original request and any duplicates thereof have matching request IDs, this automatically makes that server the owner of the original request and all of its duplicates. Upon receiving the original request 402O, that server registers itself as the processing server for its request ID in the shared database 116 by associating its own server ID with the request ID in the shared database 116. In this context, an original request 402O means one whose request ID is not already associated with any of the servers in the cluster in the shared database 116 upon receipt. Any duplicate(s) 402D of the request 402O, having a matching request ID, may also be forwarded by the load balancer 112 to any one of the servers in the cluster 110 selected according to the load balancing mechanism. A duplicate request 402D may for example be a retry instigated by the client because for whatever reason it did not receive any response to its original request, e.g. because the response was lost in transit and/or due to server-side processing delays. The load balancer 110 does not make any attempt to distinguish duplicate requests from original requests, and in particular it does not make any attempt to forward duplicate requests to servers in dependence on where the original is forwarded. Instead, the shared database 116 is used to track which servers are handling which requests, and proxying within the cluster 110 is used to ensure that any duplicate request 402D is forwarded to the same server that handled or is currently handling the original request 402O.

A request 402 is received via the load balancer 112 at the transport layer 302a of the first server, having originated from the client 107. The request 402 is passed from the transport layer 302a to the idempotency layer 304a of the first server 114a, where it is received at step S502. At steps S504-S508, the idempotency layer 304a determines whether the request ID in the message header of the request 402 is already associated with any server in the shared database 116, i.e. it determined whether the request is a duplicate request 402D, and if so, the identity of the processing server for its request ID (“messageID”). If it is determined that there is not already a processing server for messageID, thereby determining that the request is an original request 402O, or if there is but the processing server happens to be the first server 114, i.e. if the request 402 is a duplicate 402D that happens to have landed on the same server as the corresponding original request, then the processing of the request is handled entirely by the first server 114a in steps S509-S520. Otherwise, i.e. if the request is a duplicate 402D and the first server 114a is not the processing server for messageID, the first server 114a forwards the request to the processing server (the second server 114b in the example below) at step S522 as described below.

Further details of the implementation of steps S504-S520 by the idempotency layer 304a are given below. However, as will be appreciated, there are other ways in which the operations set out in the preceding paragraph can be implemented, that are within the scope of this disclosure.

Upon receiving the request 402 from the transport layer 302a at step S502, the idempotency layer 304a of the first server 114a attempts to create an entry in the shared storage 116 having messageID as its key and the first server's server ID (“instanceID1”) as its value (S504). This attempt is made without checking whether or not such an entry already exists in the database 116. If the creation succeeds (S506), this means that this is the first attempt at creating a record with this key, which, in turn, means that messageID is not already associated, in the shared database 116, with any server in the cluster 110 i.e. the request is an original request 402O. Once created, this entry identifies the server 114a, to all of the servers in the cluster 110 as the processing server for messageID. In that event, the method proceeds to step S509.

If the creation of a new entry in the database 116 fails at step S504, the shared database 110 returns an error which indicates that an entry with the messageID key already exists. This means that messageID is already associated with one of the servers in the cluster 110 which, in turn, means the request 402 is a duplicate 402D of an original request received previously within the cluster 110. In that event, at step S508, the existing entry is read and the method branches depending on whether or not the server associated with messageID is the first server 114a itself; if so, i.e. if messageID is already associated with instanceID1, this means that the duplicate request 402 happens to have landed on the processing server for that request. In that event, the method also proceeds to step S509, and proceeds from in the same manner as if the creation had succeeded at step S506. If, on the other hand, a different server (e.g. the second server 114b) registered in the database 116 as the processing server for messageID, the method proceeds differently to step S522 as described later.

The idempotency layer 304a implements steps S509-S520 by the following operations. The operations are performed in a thread-safe manner, which can be achieved using known server side processing methodologies.

Note that, for the sake of simplicity, the signalling flow corresponding to steps S502-508 is not shown in FIG. 6A or 6B, but only in FIG. 6C. Further, FIG. 6C omits the internal signalling within the servers for simplicity (this is shown in FIGS. 6A and 6B).

At step S509, the idempotency layer 403a generates a token (“wait token”), and attempts to insert it in the local dictionary 214a implemented in the local memory of the first server 114a, in association with messageID. In particular, it attempts to create a new entry in the dictionary 214a that indexed by messageID. This attempt is made irrespective of whether the request 402 is an original or a duplicate 402O, 402D, i.e. step S509 is agnostic to the type of request in this respect.

If this attempt succeeds (S510), this means that no such previous entry exists in the dictionary 214a, which in turn means that the request 402 is an original request 402O. If the entry comprising the wait token is successfully created, then the idempotency layer 304 passes the request 402 to business logic layer 306a for processing (S518). The wait token is initially empty (i.e. unpopulated), and in this unpopulated form serves as an indicator that the request is currently being processed by the business logic layer 306a.

Only original requests 402O are ever passed to the business logic layer 306a—duplicate requests are handled entirely by the lower idempotency layer 304a. The business logic layer 306a generates a response (408 in FIGS. 6A-6C) to the request 402O and, once generated, passes it back down to the idempotency layer 304a, where it is received at step S520 by the idempotency layer 304a. The idempotency layer 304a stores the received response in its local dictionary 214a in association with messageID, by storing in the previously-unpopulated wait token (S520). That is, the idempotency layer 304a populates the wait token with the response 408. A copy of the response 408 is also passed down to the transport layer 302a (S516), and from there transmitted to the requesting client 107.

FIG. 6A shows an exemplary signalling flow, the top part of which shows signalling between the client 107a and within the server 114a, when an original request 402O is received and passed up to the business logic layer 306a, corresponding to the sequence of steps S509, S510, S518, S520 and S516 i.e. the middle branch of the flow chart of FIG. 5.

Returning to step S510, if, on the other hand, the attempt of step S509 to create the new entry in the local dictionary 214a has failed, this means that a wait token already exists therein for messageID, which in turn means that either the response 408 is still being generated by the business logics layer 306a or has already been generated and sent to the client 107a. The failed attempt allows the idempotency layer to locate the existing wait token associated with messageID that is already present in the dictionary 214a. If the existing wait token is already populated with a response 408 (S512), the method proceeds step S516, at which a copy of the response held in the existing wait token is passed down to the transport layer 302a for transmission to the requesting client 107 in the same manner as described above. An example is shown in the bottom half of FIG. 6A. In this example, a duplicate request 402D has been sent as the response 408 to the original 402O was lost in transit to the client 107a. The duplicate response 402 in this example happens to land on the first server 114a also after the wait token has been populated with the response 408, triggering the sequence of steps S510, S512, to S516.

If on the other hand, the existing wait token is unpopulated, the idempotency layer 304a can safely ignores the request (S514) as the fact that no response is available in the local dictionary 214a yet means the business logic layer 306a is still in the process of generating it, and that it will be transmitted to the requesting client 107 in due course (i.e. at step S516 for the original request 402O). Alternatively, the idempotency layer 304a can wait for the response 408 to be generated and, once generated, send another copy of the response to the client in response to the duplicate (i.e. such that two copies of the response are sent once generated—one in response to the original, one in response to the duplicate)—this is also entirely safe, though it may not always be necessary. An example is shown in FIG. 6B, in which a duplicate response 402D is transmitted by the client because no reply has been received to its original request 402O, e.g. due to server-side proceeding delays. In this example, it is also assumed for the sake of simplicity that the duplicate 402D lands on the same server 114a as the original request 402O, triggering the sequence of steps S509, S510, S512 to S514.

After a sufficient duration from the creation of the wait token has passed, the wait token is removed from the server dictionary 114a to free up memory. The interval of time is chosen so that it is longer than a client side timeout duration.

Returning to step S508, as noted if messageID is associated with a different one of the servers in the existing record—e.g. the second server 114b whose server ID is instanceID2—this means that the original request, of which the received request 402 is a duplicate, was received at the different server 114b the different server 114b identified in the value of the existing record (e.g. by instanceID2). In that event the idempotency layer 304a of the first server 114a forwards (S522) the request 402 to different server 114b i.e. to the processing server 114b identified in the entry. The forwarded copy of the request has the same messageId.

On receipt of the forwarded message, the idempotency layer on the processing server 114b will ensure that the forwarded request does not cause any side-effect and is responded to with the same response that was cached for original attempt, by implementing the same method independently.

The request 402 is proxied to the first server 114a to the second server 114b, i.e. having forwarded the request to the second server 114b, at step S524 the idempotency layer 304a of the first server 114a receives a response to the request 402 from the second server 114b which it forwards to the requesting client 107a.

This is illustrated in FIG. 6C, which shows an original request 402O being received and processed at the first server 114a, and a duplicate response 402D being received at the second server 114b whilst the processing of the original response 402O by the first server 114a is still ongoing. The second server 114a forwards the duplicate response 402D to the first server, which returns the response 408 once generated. The second server transmits the returned response 408 to the client 107a. The first server may also send a copy of the response 408 to the client 107a in response to the original request 402O though this is not shown explicitly, alternatively or in addition. That is, in the event that a duplicate request 402D is received on the second server whilst the first server 14a is still processing the original 402O, once the response 408 is generate either or both of the servers may transmit a copy of the response to the client 107a.

This proxying is invisible to the client 107, as the client only communicates with the first server 114a directly. This means that the client need only communicate with a single server in an end-to-end fashion, which may be beneficial in terms of end-to-end security and also reduces the burden placed on the client.

With regards to this proxying aspect, note that in the event that the request 302 is received at the first server, at step S504, from another server in the cluster (as opposed to from the client 107 via the load balancer 112 directly), the copy of the response that are transmitted at steps S516 or S520 is transmitted to the other server, from where it is transmitted to the client 107. That is, where the request is received at the processing server from another server rather than the requesting client 107a directly, that other server takes the place of the client 107a in the method of FIG. 5, and is a requesting entity from the perspective of the processing server.

Clean-up (i.e. deletion) of each entry in shared store 116 is performed after a duration from its creation that is sufficiently larger than client side timeout to avoid any race condition.

For the purposes of illustration, in the above, an example is described in which an original request 402O is received at the first server 114a of the cluster 110. Two further examples are then considered. In the first of these examples, a duplicate of the original request 402O is received at the first server 114a (such that no proxying is needed). In the second of these examples, the duplicate request 402D is received at the second server 114b of the server 114b and forwarded to the first server 114a. This is exemplary, and in general, as noted above, an original request can be forwarded by the load balancer to any available on of the server in the cluster 110, wherein the requesting entity may be a client or another server.

Any number of duplicate requests may be received at the load balancer 110, each of which may be forwarded to any one of the servers in the cluster 110, which may or may not happen to be the server that handled the original. By configuring each server in the cluster 110 to implement the method of FIG. 5, the cluster as a whole is able to handle any such eventuality, ensuring that any duplicate request is eventually forwarded to the same server that is handling or has handled the original request. The method is implemented independently by the servers, in that each server performs each step of the method independently of the other server(s) in the cluster 110. However, the outcomes of those independently performed steps are mutually dependent at they depend on the extent to and manner in which the shared database 116 is populated. Accordingly, any of the description pertaining to the first server 114a or the second server 114b in describing FIG. 5 applies equally to any other server in the cluster 110 when receiving any original or duplicate request.

Note that the above-described methodology can be extended to achieve idempotency when retries from client may land on different clusters (rather than just different servers in the same cluster). Duplicate requests may land on different clusters, for example where a DNS returns the network addresses of a different cluster in response to a particular URI at different times. This can happen for a number of reasons, for example if the client is detected to have moved (the DNS will generally attempt to return the network address of the nearest cluster geographically) or if a cluster is becoming overloaded (some DNS's can take this into account).

If server within one cluster is not directly addressable from another cluster, a two-step proxying process can be used. The first level ensures a duplicate request reaches the correct cluster i.e. the same cluster as received the original. The second level is performed within that cluster in the manner described above, to ensure that the duplicate request reaches the correct server within the correct cluster. The correct cluster returns the response to the server in the cluster that received the duplicate request, which in turn forwards it to the requesting client. That is, proxying takes places between different clusters not just individual servers within one cluster.

To implement the first level of clustering, a global database accessible to each of the multiple clusters is used to associate request IDs with individual clusters. When a request is received by given server in a cluster, it first checks whether its request ID is already associated with a different one of the clusters in the global database i.e. with a cluster ID of that cluster. If so, the server forwards it to the load balancer of the identified cluster, from which it is handled in the manner described above.

In this context, a requesting entity can be a client, another server in the same cluster, or a different cluster altogether. Requests may be proxied between different clusters, in a manner equivalent to the internal proxying described above.

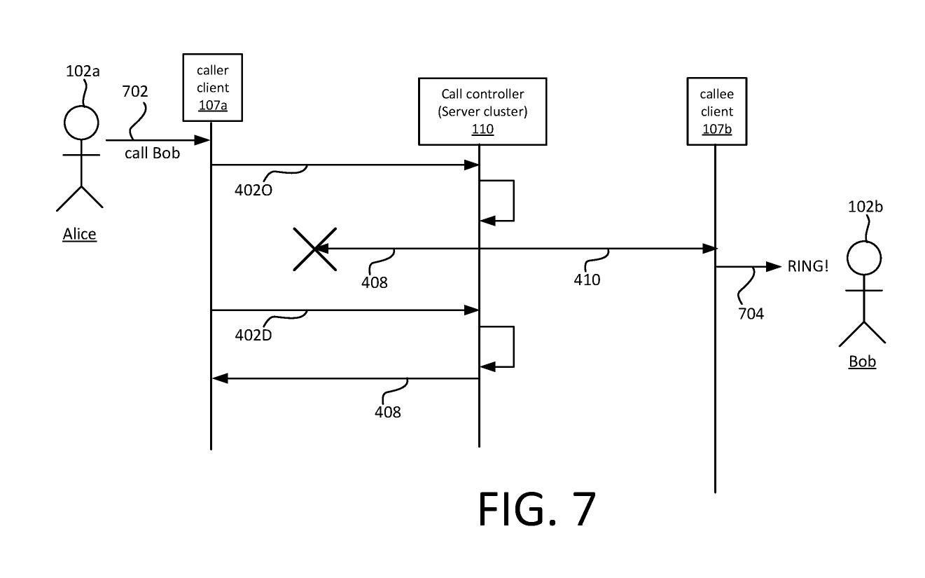

FIG. 7 illustrates a particular use-case, in which the server cluster 110 is configured to operate as a communications controller, such as a call controller. In this example, the clients 107a, 107b are communications client for effecting communication events, such as calls (e.g. VoIP calls) via the network 108.

In response to the first user 102a (“Alice”) instigating a call establishment instruction at her user device 106a, denoted by user input 702 at the user device 106a, the first client 107a transmits an original call request 302O to the call controller 110. The call request contains a previously-unused request ID and also identifiers the second user 102b (“Bob”) and/or his device 104b and/or the second client running on his device 107b. For example, the request 302O may contain Bob's username or other user ID, or a network or device identifier associated with his device 104b and/or client 107b.

The request 302O is received at the load balancer 112 of the call controller 110, and from there forwarded to an available one of the servers in the cluster (not shown explicitly in FIG. 7). At that server, it is passed up to the idempotency layer and from there to the business logics layer (as it is an original request). The business logics layer processes the request and, assuming the request 302O is authorized, generates both a response 308 to be transmitted to Alice's client 107b and a call invite 310 to be transmitted to Bob's client 107b. In this example, the invite 310 is successfully received by Bob's client 107b, causing it to output an incoming call notification 704 (e.g. an audible ringing) to Bob. However, the response 308 is lost in transit to Alice's client 107a. The absence of any response within an expected time interval causes Alice's client 107b to retry the request 302O i.e. to send a duplicate 302D of the request 302O, with the same request ID, to the call controller 110. This duplicate request 302D is handled according to the method set out above, resulting in another copy of the response 308 being sent to Alice's client 107a by the same server as handled the original request 302O. In performing this method, that server becomes aware that the request 302D is a duplicate, and therefore does not send any duplicate of the call invite 310 to Bob's client 107b.

Note the term “database” herein is not limited to the specific examples described above. In general, references to a database that is accessible to multiple entities simply means any suitable collection of data that is stored such that, if modified or added to by one of those entities, the modification of addition becomes visible to the other entity or entities. This includes, for example, distributed databases, such as a distributed database implemented by the servers in cluster themselves, rather than in separate central storage (as in the above described embodiments). For example, an alternative implementation of the shared database 116 within the cluster 110 would be a distributed implementation, by which each of the servers maintains a local “master” record of whichever request IDs it is responsible for, and communicates any updates to that local record to the other server(s) in the cluster (a form of distributed database duplication).

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

A first aspect of the present subject matter is directed to a method of processing duplicate requests within a cluster of servers, wherein the servers have access to a cluster database for associating individual servers of the cluster with request identifiers, the method comprising implementing by each of the servers the following steps: receiving a request at the server from a requesting entity, wherein the request includes an identifier of the request; and processing the received request, by the server applying operations of: determining whether the request identifier is already associated with any of the servers in the cluster database, if the request identifier is already associated with a different one of the servers in the cluster database, forwarding the request to the different server for processing thereat, if the request identifier is not already associated with any of the servers in the cluster database: associating the request identifier with the server therein, generating a response to the request, and, once generated, storing the response in association with the request identifier in local storage accessible to the server and transmitting a copy of it to a requesting entity, and if the request is already associated with the server in the cluster database, using the request identifier to locate any response to the request that is already stored in the local storage accessible to the server, and if located transmitting a copy of it to the requesting entity.

In embodiments, the requesting entity may be an entity external to the cluster (e.g. a client or an external server) or another server in the cluster.

The request may identify a target client, wherein if the request identifier is not already associated with any of the servers in the cluster database the server may also transmit a message to the target client based on the request; and wherein if the request is already associated with the server in the cluster database, the server may transmit the copy of the response to the requesting client but does not transmit any message to the target client based on the request.

For example, the message may be a communication event invite, which causes a communication event to be established between a user associated with the request and a user of the target client. For example, the communication event is a call between the users.

If the request identifier is already associated with a different one of the servers in the cluster database, upon receiving at the server a response to the request from the different server, the server may forward the response to the requesting entity.

Each of the servers of the cluster may be connected to a common load balancer, and the request may be received via the load balancer.

If the request identifier is not already associated with any of the servers in the cluster database:
if a duplicate of the request is received at the server after it has received the request but before it has generated and stored the response, the server may ignore the duplicate request and/or wait for the response to be generated; and
if a duplicate of the request is received at the server after the response has been stored in the local storage, the server may use the request identifier in the duplicate request to locate the stored response and transmits another copy of it to the requesting entity.

For example, if the request identifier is not already associated with any of the servers in the cluster database, upon receiving the request, the server may generate in the local storage, in association with the request identifier, an indicator of the request, and then store the response once generated in association with the request identifier in the local storage; wherein if a duplicate of the request is received after the indicator has been stored but before the response has been stored in the local storage, the server may use the request identifier in the duplicate request to locate the indicator, wherein the server may ignore the duplicate response and/or wait for the response to be generated in that event; wherein if a duplicate of the request is received after the response has been stored in the local storage, the server may use the request identifier in the duplicate request to locate the stored response in the local storage and transmit another copy it to the requesting entity.

For example, the indicator may be a token that is initially unpopulated, wherein the response may be stored in in association with the request identifier in the local storage by populating the token with the response.

If the request is not already associated with a different one of the servers in the cluster database, the server may attempt to generate in the local storage, in association with the message identifier, an indicator of the request irrespective of whether any indicator is already associated with the request identifier in the local storage, wherein the attempt fails if an existing indicator is already associated with the request identifier in the local storage thereby locating the existing indicator.

The message may be received at a transport layer of the server and passed to an application layer of the server above the transport layer, wherein the request processing operations may be implemented at the application layer of the server.

The generating operation by which the response is generated may be implemented at an operational layer of the application layer, wherein the remaining request processing operations may be performed at an idempotency layer of the application layer, below the operational layer, whereby the response is only passed to the operational layer from the idempotency later if the request identifier is not already associated with any of the servers in the cluster database when the request is received.

Upon receiving the request, the server may attempt to associate itself with the request identifier in the cluster database irrespective of whether any of the servers is already associated with the request identifier in the cluster database, wherein the attempt fails if any of the servers is already associated with the request identifier in the cluster database thereby identifying that server.

A second aspect of the present subject matter is directed to a method of processing duplicate requests across a plurality of clusters of servers, wherein each of the clusters has access to a global database for associating individual clusters with request identifiers, wherein the servers in each cluster have access to a cluster database for associating individual servers of the cluster with request identifiers, wherein the method comprises implementing by each server in each of the clusters the following steps: receiving a request at the server from a requesting entity, wherein the request includes an identifier of the request; and determining whether the request identifier is already associated with any of the clusters in the global database; if the request is already associated with a different one of the clusters, forwarding the request to the different cluster for processing thereat; if the request is not already associated with any of the clusters in the global database, associating the cluster with the request identifier therein, and processing the request by applying the request processing operations of the first aspect; and if the request is already associated with the cluster in the global database, processing the request by applying the request processing operations of the first aspect.

In embodiments, the requesting entity is a client, another server in the cluster, or a server in another of the clusters.

According to a third aspect of the present subject matter, a system comprises: a cluster of servers; and a cluster database, to which the servers have access, for associating individual servers of the cluster with request identifiers; wherein each of the servers in the cluster is configured to implement the following steps: receiving a request at the server from a requesting entity, wherein the request includes an identifier of the request; and processing the received request, by the server applying operations of: determining whether the request identifier is already associated with any of the servers in the cluster database, if the request identifier is already associated with a different one of the servers in the cluster database, forwarding the request to the different server for processing thereat, if the request identifier is not already associated with any of the servers in the cluster database: associating the request identifier with the server therein, generating a response to the request, and, once generated, storing the response in association with the request identifier in local storage accessible to the server and transmitting a copy of it to a requesting entity, and if the request is already associated with the server in the cluster database, using the request identifier to locate any response to the request that is already stored in the local storage accessible to the server, and if located transmitting a copy of it to the requesting entity.

In embodiments, the servers may be virtual servers implemented by a set of one or more processing units of the system.

According to a third aspect of the present subject matter, a computer program product comprising code stored on a computer readable storage medium and configured, when executed on each server in a cluster of servers, to cause the server to implement the following steps: receiving a request at the server from a requesting entity, wherein the request includes an identifier of the request; and processing the received request, by the server applying operations of: determining whether the request identifier is already associated with any of the servers in a cluster database, the cluster database for associating individual servers of the cluster with request identifiers, if the request identifier is already associated with a different one of the servers in the cluster database, forwarding the request to the different server for processing thereat, if the request identifier is not already associated with any of the servers in the cluster database: associating the request identifier with the server therein, generating a response to the request, and, once generated, storing the response in association with the request identifier in local storage accessible to the server and transmitting a copy of it to a requesting entity, and if the request is already associated with the server in the cluster database, using the request identifier to locate any response to the request that is already stored in the local storage accessible to the server, and if located transmitting a copy of it to the requesting entity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of processing duplicate requests within a cluster of servers, wherein the servers have access to a cluster database for associating individual servers of the cluster with request identifiers, the method comprising implementing by each of the servers the following steps:
receiving a request at the server from a requesting entity, wherein the request includes an identifier of the request; and
processing the received request, by the server applying operations of:
determining whether the request identifier is already associated with any of the servers in the cluster database,
if the request identifier is already associated with a different one of the servers in the cluster database, forwarding the request to the different server for processing thereat,
if the request identifier is not already associated with any of the servers in the cluster database: associating the request identifier with the server therein, generating a response to the request, and, once generated, storing the response in association with the request identifier in local storage accessible to the server and transmitting a copy of it to a requesting entity, and
if the request is already associated with the server in the cluster database, using the request identifier to locate any response to the request that is already stored in the local storage accessible to the server, and if located transmitting a copy of it to the requesting entity.

2. A method according to claim 1, wherein the requesting entity is an entity external to the cluster or another server in the cluster.

3. A method according to claim 2, wherein the entity external to the cluster is a client.

4. A method according to claim 1, wherein the request identifies a target client;
wherein if the request identifier is not already associated with any of the servers in the cluster database the server also transmits a message to the target client based on the request; and
wherein if the request is already associated with the server in the cluster database, the server transmits the copy of the response to the requesting client but does not transmit any message to the target client based on the request.

5. A method according to claim 4, wherein the message is a communication event invite, which causes a communication event to be established between a user associated with the request and a user of the target client.

6. A method according to claim 5, wherein the communication event is a call between the users.

7. A method according to claim 1, if the request identifier is already associated with a different one of the servers in the cluster database, upon receiving at the server a response to the request from the different server, the server forwards the response to the requesting entity.

8. A method according to claim 1, wherein each of the servers of the cluster is connected to a common load balancer, and the request is received via the load balancer.

9. A method according to claim 1, wherein if the request identifier is not already associated with any of the servers in the cluster database:
if a duplicate of the request is received at the server after it has received the request but before it has generated and stored the response, the server ignores the duplicate request and/or waits for the response to be generated; and
if a duplicate of the request is received at the server after the response has been stored in the local storage, the server uses the request identifier in the duplicate request to locate the stored response and transmits another copy of it to the requesting entity.

10. A method according to claim 9, wherein if the request identifier is not already associated with any of the servers in the cluster database:
upon receiving the request, the server generates in the local storage, in association with the request identifier, an indicator of the request, and then stores the response once generated in association with the request identifier in the local storage;
wherein if a duplicate of the request is received after the indicator has been stored but before the response has been stored in the local storage, the server uses the request identifier in the duplicate request to locate the indicator, wherein the server ignores the duplicate response and/or waits for the response to be generated in that event;
wherein if a duplicate of the request is received after the response has been stored in the local storage, the server uses the request identifier in the duplicate request to locate the stored response in the local storage and transmits another copy it to the requesting entity.

11. A method according to claim 10, wherein the indicator is a token that is initially unpopulated, wherein the response is stored in in association with the request identifier in the local storage by populating the token with the response.

12. A method according to claim 1, wherein if the request is not already associated with a different one of the servers in the cluster database, the server attempts to generate in the local storage, in association with the message identifier, an indicator of the request irrespective of whether any indicator is already associated with the request identifier in the local storage, wherein the attempt fails if an existing indicator is already associated with the request identifier in the local storage thereby locating the existing indicator.

13. A method according to claim 1, wherein the message is received at a transport layer of the server and passed to an application layer of the server above the transport layer, wherein the request processing operations are implemented at the application layer of the server.

14. A method according to claim 13, wherein the generating operation by which the response is generated is implemented at an operational layer of the application layer, wherein the remaining request processing operations are performed at an idempotency layer of the application layer, below the operational layer, whereby the response is only passed to the operational layer from the idempotency later if the request identifier is not already associated with any of the servers in the cluster database when the request is received.

15. A method according to claim 1, wherein upon receiving the request, the server attempts to associate itself with the request identifier in the cluster database irrespective of whether any of the servers is already associated with the request identifier in the cluster database, wherein the attempt fails if any of the servers is already associated with the request identifier in the cluster database thereby identifying that server.

16. A method of processing duplicate requests across a plurality of clusters of servers, wherein each of the clusters has access to a global database for associating individual clusters with request identifiers, wherein the servers in each cluster have access to a cluster database for associating individual servers of the cluster with request identifiers, wherein the method comprises implementing by each server in each of the clusters the following steps:
receiving a request at the server from a requesting entity, wherein the request includes an identifier of the request; and
determining whether the request identifier is already associated with any of the clusters in the global database;
if the request is already associated with a different one of the clusters, forwarding the request to the different cluster for processing thereat;
if the request is not already associated with any of the clusters in the global database, associating the cluster with the request identifier therein, and processing the request by applying the request processing operations of claim 1; and
if the request is already associated with the cluster in the global database, processing the request by applying the request processing operations of claim 1.

17. A method according to claim 16, wherein the requesting entity is a client, another server in the cluster, or a server in another of the clusters.

18. A system comprising:
a cluster of servers; and
a cluster database, to which the servers have access, for associating individual servers of the cluster with request identifiers;
wherein each of the servers in the cluster is configured to implement the following steps:
receiving a request at the server from a requesting entity, wherein the request includes an identifier of the request; and
processing the received request, by the server applying operations of:
determining whether the request identifier is already associated with any of the servers in the cluster database,
if the request identifier is already associated with a different one of the servers in the cluster database, forwarding the request to the different server for processing thereat,
if the request identifier is not already associated with any of the servers in the cluster database: associating the request identifier with the server therein, generating a response to the request, and, once generated, storing the response in association with the request identifier in local storage accessible to the server and transmitting a copy of it to a requesting entity, and
if the request is already associated with the server in the cluster database, using the request identifier to locate any response to the request that is already stored in the local storage accessible to the server, and if located transmitting a copy of it to the requesting entity.

19. A system according to claim 18, wherein the servers are virtual servers implemented by a set of one or more processing units of the system.

20. A computer program product comprising code stored on a computer readable storage medium and configured, when executed on each server in a cluster of servers, to cause the server to implement the following steps:
receiving a request at the server from a requesting entity, wherein the request includes an identifier of the request; and
processing the received request, by the server applying operations of:
determining whether the request identifier is already associated with any of the servers in a cluster database, the cluster database for associating individual servers of the cluster with request identifiers,
if the request identifier is already associated with a different one of the servers in the cluster database, forwarding the request to the different server for processing thereat,
if the request identifier is not already associated with any of the servers in the cluster database: associating the request identifier with the server therein, generating a response to the request, and, once generated, storing the response in association with the request identifier in local storage accessible to the server and transmitting a copy of it to a requesting entity, and
if the request is already associated with the server in the cluster database, using the request identifier to locate any response to the request that is already stored in the local storage accessible to the server, and if located transmitting a copy of it to the requesting entity.
